(19) United States
(12) Patent Application Publication
(10) Pub. No.: US 2009/0078162 A1
(43) Pub. Date: Mar. 26, 2009

(54) Gypsum-based Composition

(76) Inventors: Robert N. Clausi, Oakville (CA); Savaltore Diloreto, Ancaster (CA)

Correspondence Address: GOWAN INTELLECTUAL PROPERTY, 1075 NORTH SERVICE ROAD WEST, SUITE 203, OAKVILLE, ON, L6M-2G2, CA

(21) Appl. No.: 12/293,397

(22) PCT Filed: Mar. 9, 2007
(86) PCT No.: PCT/CA2007/000410

§ 371 Date: Sep. 17, 2008

Related U.S. Application Data
(60) Provisional application No. 60/783,020, filed on Mar. 17, 2006.

(51) Int. Cl. C04B 28/14; C04B 14/02; C04B 16/10; C04B 20/02; C04B 38/08; B28B 1/14; B28B 1/16

(52) U.S. Cl. 106/783; 106/772; 106/785; 106/784; 524/5; 264/241; 264/299

(57) ABSTRACT

A light-weight gypsum-based composition is provided which is particularly suitable for use in the production of wall panels. The composition comprises: (i) gypsum; (ii) glass, ceramic or polymer microspheres; and (iii) a coupling agent preferably selected from a silane or metal coupling agent. The resultant panel has good strength properties and has good performance with respect to nailability and cutability. Further, the paper backing commonly used on traditional commercial drywall panels can be optionally eliminated. The composition can also be cast into thicker products. A lightweight wall panel material is provided.

### FIELD OF THE INVENTION

The present invention relates to the field of gypsum-based compositions, and in particular, to the use of the compositions in the fabrication of building panels from gypsum. This includes gypsum panels commonly referred to as “drywall” panels.

### BACKGROUND OF THE INVENTION

In North America most residential or light weight construction applications rely on the use of gypsum panels which are hung from wood or metal stud walls in order to provide a plaster-like wall or ceiling structure. These “wall” panels are commonly referred to a “drywall” panels, and are usually prepared from a layer of essentially 100% gypsum which has been deposited as an aqueous slurry between two sheets of backing paper.

Drywall panels are traditionally manufactured in a continuous process. In the process, a gypsum slurry is first generated in a mechanical mixer by mixing calcium sulfate hemihydrate (also known as calcined gypsum), water, and other agents. These other agents include various additives such as set accelerators (such as ground gypsum, potassium sulphate, etc.), set retarders (such as diethylene triamine tetra acetic acid), water reducing agents (such as condensed naphthalene sulphonates), foaming agents (such as lauryl alcohol ether sulphates), liner bonding agents (such as starch), anti-burning agents (such as boric acid), glass fibres for improved physical properties and fire resistance, other agents to improve reaction to fire properties (such as clay), water proofing agents (such as wax or silicones), or other agents to provide additional features.

The aqueous gypsum slurry is deposited on a paper sheet which has had each edge scored or creased to facilitate the folding of the edges to make a sidewall of a height equal to board thickness and a further flap of width about 1 inch wide folded back over the board. An upper continuously advancing paper sheet is then laid over the gypsum slurry and the edges of the upper and lower sheets are pasted to each other using glue at the edges of the top and/or bottom sheet. The paper sheets and gypsum slurry are passed between parallel upper and lower forming plates or rolls in order to generate an integrated and continuous flat strip of unset gypsum which is sandwiched between the paper sheets that are known as facing or liners. This strip is conveyed over a series of continuous moving belts and rollers for a period of 2 to 5 minutes during which time the core begins to hydrate back to gypsum (calcium sulphate dihydrate) and hardens. Once the gypsum core has set sufficiently, the continuous strip is cut into shorter lengths or even individual boards or panels of prescribed length.

After the cutting step, the gypsum boards are fed into drying ovens or kilns where the boards are dried so as to evaporate excess water. The conversion from the hemihydrate form to the gypsum dihydrate form is essentially complete by this point.

Gypsum wall panel composition and manufacture has been the subject of numerous patents. Typically, standard gypsum wall panels are produced with a cellulosic paper liner. However, there are several disadvantages to the use of paper as a liner for gypsum board. Paper acts as a food source for mold and mildew, and it becomes especially weak and subject to delamination either directly from the gypsum core or between the layers of the multi-layer sheets when the paper becomes damp due to water leaks or high humidity. Also, the paper is burnable and usually needs to be treated to minimize its flammability.

While other backing materials such as polymeric fibres or the like, are known, the use of paper as a backing material is by far the most common backing material.

The backing material is commonly used in order to provide a structural stability to the panel to reduce the effects of the normally brittle gypsum structure. As a result, the backing material allows the gypsum material to have adequate properties with respect to nailability (e.g. the ability to nail the panel to a wall or ceiling, and including either nails or screws), or cutability (e.g. the ability to cut the panel to a desired shape or size without excessive crumbling or breakage).

A further common problem with gypsum panels however, is their weight. For example, a typical 12 mm, 4 ft by 8 ft. panel can have a weight of over 20 kg. Since the thickness of the board affects its physical and mechanical properties, the desirability to have a thicker, stronger panel must frequently be offset by the need to provide a thinner panel having less weight. Accordingly, the nominal thickness of gypsum “drywall” panels is typically 6 mm to 21 mm with a 12 to 16 mm thick panel being most common.

A preferred gypsum panel should therefore include the features that:
the panel should be capable of being fastened to framing with nails or screws (nailability), and be capable of being easily cut to a particular size or shape (cutability);
the panel should not be biodegradable or subject to attack by mould, insects or rot;
the panel should be non-combustible; and
the panel should have the lowest weight possible while providing the desired strength properties.

To improve the strength of the panels, various attempts have been made to at least partially replace some of the gypsum material with hydraulic cement-based materials. However, these materials do not typically possess the combination of low density, nailability and cuttability which would be required to enable the panel to be cut or fastened (either nailed or screwed) with conventional carpentry tools.

These gypsum-cement compositions can also be reinforced with glass fibers and, with the addition of microspheres, have a reduced weight when compared with typical hydraulic cement panels. However, while glass fibers have been used to reinforce cement, they are known to lose strength with time since the glass is attacked by the lime present in the cured cement. This may be offset, to some extent, by coating the glass fibers or by using a special alkali-resistant glass. Other fibers have been suggested to reinforce cement, such as metal fibers, wood or other cellulose fibers, carbon fibers, or polymer fibers.

Notwithstanding this, cement-based panels and structures containing lightweight particles of glass, ceramics and polymers in order to reduce weight are known. However, this has been done at the expense of reduced strength, or a reduction in other properties. While the use of other aggregates is also known in the gypsum-cement compositions, they do not provide the weight advantages of the lightweight, microsphere particles.

As such, these panels will satisfy some of the performance requirements listed above. However, their weight and composition are typically not capable of meeting all of the desired performance criteria, and are therefore distinguished from the compositions discussed hereinbelow.

Gypsum-cement compositions are disclosed generally in U.S. Pat. Nos. 5,858,083 and 5,958,131. Additionally, in U.S. Pat. No. 4,379,729, three layers are used in panels intended to replace wood for concrete forms. The outer two layers are glass fiber reinforced cement, while the middle layer is cement containing hollow spheres.

A thick modular wall section is discussed in U.S. Pat. No. 4,259,824. Various aggregates, including glass fibers, are suggested to be useful.

A gypsum-cement panel is discussed in U.S. Pat. No. 5,858,083. The panel contains wood or paper fibers rather than glass fibers. Similarly, in U.S. Pat. No. 5,371,989, a gypsum board is disclosed which has glass fiber mats on the exterior surfaces.

In U.S. Pat. No. 4,057,443, a foamed gypsum composition is described in the production of a wall panel, and in U.S. Pat. No. 4,504,320, a glass-reinforced Portland cement is described that includes fly ash cenospheres and silica fume. Further, in U.S. Pat. No. 4,824,811 a crushed concrete foam material is used as a filler for a gypsum panel.

In U.S. Pat. No. 6,620,487 a structural sheathing panel is described that comprises a mixture of gypsum, cement, an active pozzolan and lime, and which contains alkali-resistance glass fibres and ceramic and polymer microspheres. A panel having dimensionally stable properties is provided. However, this complex mixture is still used in combination with a outer layer of a cured continuous phase reinforced with glass fibres and sufficient polymer spheres to improve nailability.

In U.S. Pat. No. 4,629,751, a gypsum panel repair product is described comprising gypsum, glass microbubbles and a polyvinyl alcohol are described. However, the use of this product in a panel was not described.

As such, despite all the effort which has gone into the reinforcement of gypsum, cement or cement-gypsum combinations, as indicated by the various patents and patent applications mentioned above, none of the panels discussed therein provide a gypsum-only panel which is used in combination with microspheres, and include a novel agent to assist in bonding the microspheres to the gypsum material for the production of gypsum panels.

### SUMMARY OF THE INVENTION

The present invention therefore provides a simpler formulation for manufacture while providing an adequate combination of low density and ductility required for panel handling and nailability by using gypsum in combination with lightweight hollow microspheres which are preferably uniformly distributed throughout the full thickness of the panel, and a coupling agent, in particular, a metal or silane-based coupling agent.

This blend of a substantial quantity of lightweight microspheres throughout the full thickness of the panel provides a panel of reduced density while the coupling agent allows for greater stability and strength of the panel which provides the desired nailability or cutability properties.

Accordingly, it is a principal advantage of the present invention to provide a relatively lightweight gypsum composition, preferably free of added cement, which is preferably suitable for use as a material suitable for use in the production of a building or construction wall panel.

The advantages set out hereinabove, as well as other objects and goals inherent thereto, are at least partially or fully provided by the gypsum-based composition of the present invention, as set out hereinbelow.

Accordingly, in one aspect, the present invention provides a gypsum-based composition suitable for use in the production of wall panels or cast structures comprising gypsum, microspheres and a coupling agent.

In a further aspect, the present invention also provides a panel constructed from the aforementioned gypsum-based composition of the present invention.

In a still further aspect, the present invention also provides a process for the production of such a panel comprising mixing gypsum, microspheres and a coupling agent with water to produce an aqueous slurry, forming said slurry into a mould optionally lined with a paper backing material and drying said slurry to remove said water.

### DETAILED DESCRIPTION OF THE INVENTION

In the present application, the term “gypsum” refers to a calcium sulphate dihydrate, but in a general sense, can also apply to other calcium sulphate materials, such as calcium sulphate hemihydrate, or the like. The present application is primarily directed to the use of the gypsum-based compositions in the production of a panel type product, such as a drywall panel. However, the skilled artisan will be aware that the compositions of the present invention might also be used in a wide variety of application, such as, for example, in a thicker, cast type application as a replacement for plaster of paris, or the like. Accordingly, while the present application is described with particular reference to the wall panel industry, the skilled artisan would be aware that the present application is equally applicable in other applications.

In producing a panel according to the present invention, hollow or light weight solid microspheres are utilized as lightweight fillers. These microspheres, as well as all other materials, are preferably uniformly distributed throughout the full thickness of the panel. In the composition, the “dry” ingredients are the reactive materials (50 to 99 wt. % calcium sulfate hemihydrate (gypsum), 0.5 to 50 wt. % microspheres, and 0.1 to 5 wt. % of the coupling agent, on a dry basis). The dry ingredients are mixed with a liquid (preferably water), to produce a slurry composition which will be used to form a panel, in accordance with the present invention.

The amount of water added to the dry ingredients is sufficient to accomplish the desired slurry fluidity needed from the processing considerations for any particular manufacturing process. The typical addition rates for water range between 35 to 60% of the weight of the dry materials.

The microspheres can be solid but preferably are hollow in order to provide minimal weight for a given volume. The microspheres may be ceramic, glass or made of a polymeric material. Combinations of the various types of microspheres can also be utilized.

It has been discovered that incorporation of microspheres in the panel, together with the coupling agent, helps to achieve the combination of low density and better nailability required to enable the panel to be cut or fastened (either nailed or screwed) with conventional carpentry tools. However, since the water-to-dry materials ratio can also affect density and nailability, the ratio may be adjusted.

It also has been found that the rheological properties of the slurry are improved substantially by utilizing a combination of ceramic and polymer microspheres in the composition.

The microspheres are preferably uniformly distributed in the aqueous slurry used to produce the panel, and thus, are essentially uniformly distributed in the dry panel.

The principal starting materials used to make panels of the invention are gypsum, microspheres, and coupling agent.

### “Gypsum”

The term “gypsum” in drywall wall panels typically refers to the dihydrate form of calcium sulfate (i.e. CaSO₄.2H₂O), or the hemihyrate form (i.e. CaSO₄.1/2H₂O). After being mined, the raw gypsum is thermally processed to form a settable calcium sulfate, which can be anhydrous, but usually is the hemihydrate, CaSO.₄.1/2H₂O. The hemihydrate has two recognized morphologies, termed alpha hemihydrate and beta hemihydrate. These are selected for various applications based on their physical properties and cost. Both forms react with water in the formation of the drywall panel to typically reform the dihydrate form. The beta hemihydrate forms less dense microstructures and is preferred for low density products. The alpha hemihydrate forms more dense microstructures having higher strength and density than those formed by the beta hemihydrate.

The gypsum material in drywall might also include a variety of additional materials, such as minor impurities, or as additives to modify its properties, as discussed hereinabove. These might include minor amounts of cellulose, silica, and or polymeric materials. However, preferably, the amount of gypsum in the gypsum material utilized, will be greater than 85%, by weight, of calcium sulfate dihydrate or calcium sulfate hemihydrate.

### Microspheres

Two types of microspheres are utilized in panels of the invention. These are: (i) Ceramic or glass microspheres; and (ii) Polymer microspheres, or mixtures thereof or therebetween.

Microspheres serve an important purpose in the panels of the invention, which would otherwise be heavier than is desirable for building panels. Used as lightweight fillers, the microspheres help to lower the average density of the product. The microspheres can be hollow or solid. When the microspheres are hollow, they are sometimes referred to as microballoons.

Ceramic microspheres can be manufactured from a variety of materials and using different manufacturing processes. Although a variety of ceramic microspheres can be utilized as a filler component in the panels of the invention, the preferred ceramic microspheres of the invention are produced as a coal combustion by-product and are a component of the fly ash found at coal fired utilities, for example, Extendospheres-SG made by the PQ Corporation. The chemistry of the preferred ceramic microspheres of the invention is predominantly silica (SiO₂) in the range of about 50 to 75% and alumina (Al₂ O₃) in the range of about 15% to 40%, with up to 35 wt. % of other materials. The preferred ceramic microspheres of the invention are hollow spherical particles with diameters in the range of 10 to 500 microns (micrometers), a shell thickness typically about 10% of the sphere diameter, and a particle density preferably about 0.50 to 0.80 g/mL. The crushing strength of the preferred ceramic microspheres of the invention is greater than 1500 psi (10.3 MPa) and is preferably greater than 2500 psi (17.2 Mpa).

Preference for ceramic microspheres in the panels of the invention primarily stems from the fact that they are about three to ten times stronger than most synthetic glass microspheres. In addition, the preferred ceramic microspheres of invention are thermally stable and provide enhanced dimensional stability to the panel of invention. Ceramic microspheres find use in an array of other applications such as adhesives, sealants, caulks, roofing compounds, PVC flooring, paints, industrial coatings, and high temperature-resistant plastic composites. Although they are preferred, it should be understood that it is not essential that the microspheres be hollow and spherical, since it is the particle density and compressive strength which provide the panel of the invention with its low weight and important physical properties. Alternatively, porous irregular particles may be substituted, provided that the resulting panels meet the desired performance.

The polymer microspheres preferably also are hollow spheres with a shell made of polymeric materials such as polyacrylonitrile, polymethacrylonitrile, polyvinyl chloride or polyvinylidine chloride, or mixtures thereof. The shell may enclose a gas used to expand the polymeric shell during manufacture. The outer surface of the polymer microspheres may have some type of an inert coating such as calcium carbonate, titanium oxides, mica, silica, and talc. The polymer microspheres have a particle density preferably between about 0.02 to 0.15 g/mL and preferably have diameters in the range of about 1 to about 1000 microns, and more preferably 10 to 350 microns (micrometers).

A blend of ceramic and polymer microspheres might also be used.

### Coupling Agent

The microspheres and/or the gypsum, are preferably modified by means of a coupling agent. This modification process, which can be a chemical modification or physical modification, improves the affinity for the gypsum to bind with the microspheres. Any suitable coupling agent may be used, but those coupling agents based on silane, or metallic materials, such as titanium and aluminum, are preferred. For example, suitable coupling agents include isopropyltriisostearoyl titanate and acetalkoxyaluminum diisopropylate. The coupling agent can be added to the mixture of gypsum and microspheres, but might also be used to “treat” the microspheres before adding them to the gypsum. This might be achieved by, for example, dissolving the coupling agent in water or an organic solvent for a predetermined period of time, and spraying with, or soaking the microspheres in the resultant solution. Alternatively, the coupling agent can be added to the water component, and then blended with a mixture of the gypsum and microspheres.

### Formulation

Panels made in accordance with the present invention will include a continuous phase consisting of calcium sulfate hemihydrate (gypsum), the microspheres, and the coupling agent, as well as any other additives which might be desired. The panels can be produced with a paper backing, as described hereinabove with reference to the prior art, or might also be produced without the paper backing. In this case, the gypsum-based composition would be placed into a suitably shaped mold and dried in the mold. By elimination of the paper, a gypsum-based composition-only panel is produced that still has acceptable nailability and cutability, and which eliminates the difficulties typically resulting from the use of paper. These difficulties includes papers' undesirable facilitation of mold growth, and being flammable.

As such, the use of the paper backing is optional with the gypsum-based material of the present invention.

The skilled artisan would readily be able to determine suitable composition levels. However, in general terms, the broad and preferred weight proportions of the materials used in the practise of the present invention will be as follows:

| | Weight Proportion (%) | Preferred Weight (%) |
|---|---|---|
| Gypsum | 50 to 99 | 60 to 95 |
| Microspheres | 0.5 to 50 | 5 to 40 |
| Coupling Agent | 0.1 to 5 | 0.5 to 3 |

### Making a Panel of the Invention

In a preferred method, panels are produced from the compositions of the present invention by the following process. The gypsum and microspheres are preferably blended together in the dry state in a suitable mixer for 1 to 5 minutes with any other additives such as, for example, a retarder (e.g., potassium tartrate) which can be added at this stage to later control the setting characteristics of the slurry. The coupling agent, if dry, can be added to the gypsum and microsphere mixture. However, the coupling agent is typically a liquid and as such, it is blended into the water which will then be added to the dry material mixture. After the water and coupling agent are added to the dry materials, the wetted ingredients is mixed for an additional 2 to 10 minutes to form a smooth homogeneous aqueous slurry.

The aqueous slurry can be utilized to produce panels, in any of a variety of techniques, as will be known in the prior art. For example, a paper backing can be used, as described hereinabove, or the slurry can be allowed to set in a suitable mold.

However, as previously noted, the composition of the present invention might also be used in the manufacture of a cast material, such as those applications where the thickness of the finished product is greater than, for example, 5 cm thick, or even 10 cm thick or more.

### EXAMPLES

The following are examples of possible methods for the production of a lightweight drywall-like panel. The panels are prepared without paper backing, and can be used and tested without this backing material. Those skilled in the art would readily be able to produce drywall-like panels from these materials, with a paper backing, if desired.

### Example 1

In a mixer vessel, 1000 grams of HYDROCAL A-11 gypsum (calcium sulfate hemihydrate) by USG with a dry bulk density of 1.5 grams/cc was combined with 90 grams of ceramic micro spheres with a bulk density of 0.29 grams/cc. The dry ingredients were mixed for 30 seconds with a three-impeller mixing blade.

In a separate container, 570 g water at 23 deg C. was combined with 3 g of amino silane Z-6020 from Dow Corning. The liquid ingredients were mixed for 30 seconds with a three impeller mixing blade.

The liquid ingredients were added to the dry ingredients and blended for approximately 8 minutes with a three impeller mixing blade at 80 rpm. The resultant thixotropic mixture was poured in a vibrating tray mold and allowed to cure for 15 to 20 minutes in a heated drying chamber with a temperature of 80 deg C. with an air flow of 4.6 meters/second.

The light-weight ceramic micro spheres-filled gypsum panel showed improved mechanical properties, thermal properties, acoustical properties, and fire and flame resistance over a conventional, commercial, drywall panel fabricated using traditional gypsum wallboard technology and no ceramic micro bubbles.

The ratio of ceramic micro spheres to silane coupling agent to gypsum will depend upon the desired properties. Preferably, however, the amount of micro spheres in this mixture is from 1 to 50%, and more preferably in the ratio of from 5 to 30% by weight of gypsum. The skilled artisan will be aware that these ranges will vary, depending on the type and amount of ceramic micro spheres, silane coupling agent, other additives, water, and gypsum selected, and on the desired properties of the final wallboard panel.

### Example 2

In a mixer vessel, 1000 grams of HYDROCAL A-11 gypsum (calcium sulfate hemihydrate) by USG with a dry bulk density of 1.5 grams/cc was combined with 50 grams of K15 glass micro bubbles with a bulk density of 0.15 grams/cc. The dry ingredients were mixed for 30 seconds with a three-impeller mixing blade.

In a separate container, 57 g water at 23 deg C. was combined with 3 g of Amino Silane Z-6020 from Dow Corning. The liquid ingredients were mixed for 30 seconds with a three impeller mixing blade.

The liquid ingredients were added to the dry ingredients and blended for approximately 8 minutes with a three impeller mixing blade at 80 rpm. The resultant thixotropic mixture was poured in a vibrating tray mold and allowed to cure for 15 to 20 minutes in heated drying chamber with a temperature of 80 deg C. with an air flow of 4.6 meters/second.

The light weight glass micro bubble-filled gypsum panel showed improved mechanical properties, thermal properties, acoustical properties, and fire and flame resistance over a drywall panel fabricated using traditional gypsum wallboard technology and no glass micro bubbles.

The ratio of glass micro bubbles and silane coupling agent to gypsum will depend upon the desired properties. Preferably, however, the amount of micro bubbles in this mixture is in the amount of from 1 to 50%, and more preferably in the ratio of from 5 to 30% by weight of gypsum. The skilled artisan will be aware that these ranges will vary, however, depending on the type and amount of glass micro bubbles, silane coupling agent, other additives, water, and gypsum selected, and on the desired properties of the final wallboard panel.

Thus, it is apparent that there has been provided, in accordance with the present invention, a light weight gypsum-based composition useful for the production of, for example, a wall panel which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

We claim:

1. A gypsum-based composition suitable for use in the production of wall panels or cast structures comprising gypsum, microspheres and a coupling agent.

2. A gypsum-based composition as claimed in claim 1 wherein said gypsum is the dihydrate form of calcium sulfate (i.e. CaSO₄.2H₂O), or the hemihyrate form (i.e. CaSO₄.1/2H₂O).

3. A gypsum-based composition as claimed in claim 1 wherein said gypsum comprises greater than 85%, by weight, of calcium sulfate dihydrate or calcium sulfate hemihydrate.

4. A gypsum-based composition as claimed in claim 1 wherein said microspheres are either (i) ceramic or glass microspheres; or (ii) polymer microspheres, or mixtures thereof or therebetween.

5. A gypsum-based composition as claimed in claim 4 wherein said microspheres are ceramic and have a particle density preferably about 0.50 to 0.80 g/mL, and a crushing strength of greater than 1500 psi (10.3 Mpa).

6. A gypsum-based composition as claimed in claim 4 wherein said microspheres are hollow polymer microspheres with a shell made of polyacrylonitrile, polymethacrylonitrile, polyvinyl chloride or polyvinylidine chloride, or mixtures thereof.

7. A gypsum-based composition as claimed in claim 6 wherein said microspheres have a particle density of between about 0.02 to 0.15 g/mL and have diameters in the range of about 1 to about 1000 microns (micrometers).

8. A gypsum-based composition as claimed in claim 7 wherein said coupling agent is based on silane, or metallic materials, such as titanium and aluminum.

9. A gypsum-based composition as claimed in claim 8 wherein said coupling agent is isopropyltriisostearoyl titanate or acetalkoxyaluminum diisopropylate.

10. A gypsum-based composition as claimed in claim 1 comprising 50 to 99% gypsum, 0.5 to 50% microspheres, and 0.1 to 5% coupling agent, by weight.

11. A gypsum-based composition as claimed in claim 1 comprising 60 to 95% gypsum, 5 to 40% microspheres, and 0.5 to 3% coupling agent, by weight.

12. A panel comprising a dry mixture formed by drying an aqueous slurry of a mixture of gypsum, microspheres and a coupling agent to form a gypsum-based composition as claimed in any of the preceding claims, and optionally lining said panel with a backing material.

13. A process for the production of a panel as claimed in claim 12 comprising mixing gypsum, microspheres and a coupling agent with water to produce an aqueous slurry, forming said slurry into a mould optionally lined with a paper backing material, and drying said slurry to remove said water.
